(19) United States
(12) Patent Application Publication
(10) Pub. No.: US 2007/0058693 A1
(43) Pub. Date: Mar. 15, 2007

(54) Tone sensing and nulling in frequency-hopped multicarrier system

(76) Inventors: Turgut Aytur, Plattsburgh, NY (US); Stephan ten Brink, Irvine, CA (US); Ravishankar H. Mahadevappa, Irvine, CA (US); Ran Yan, Holmdel, NJ (US)

Correspondence Address: CHRISTIE, PARKER & HALE, LLP, PO BOX 7068, PASADENA, CA, 91109-7068, US

(21) Appl. No.: 11/494,072

(22) Filed: Jul. 27, 2006

Related U.S. Application Data
(60) Provisional application No. 60/703,070, filed on Jul. 27, 2005.

(51) Int. Cl. H04B 1/00; H04K 1/10

(52) U.S. Cl. 375/130; 375/260

(57) ABSTRACT

A method and system for removing frequencies interfering with a UWB OFDM receiver from transmission frequencies of the UWB communication. A sensing mechanism is added to the receiver that develops an energy histogram for the frequencies in a received signal and develops a tone mask for masking the interfering frequencies. The tone mask is applied after a mapping stage in the transmitter of the UWB communication and removes the interfering frequencies from the transmitted signal. Various criteria based on energy averaging are used to identify and null and remove the interfering frequencies.

### CROSS-REFERENCE TO RELATED APPLICATION(S)

The present application claims priority to the U.S. Provisional Patent Application No. 60/703,070 filed on Jul. 27, 2005, the entire contents of which are incorporated herein by reference.

### BACKGROUND OF THE INVENTION

The present invention relates generally to ultrawideband (UWB) communication and orthogonal frequency division multiplexed (OFDM) signals in UWB communication, and more particularly to interference tone suppression in OFDM UWB communication systems.

Often UWB transmissions have an emitted signal bandwidth which exceeds the lesser of 500 MHz or 20% of the bandwidth. Thus, an aggregation of at least 500 MHz worth of narrowband carriers, for example in an OFDM fashion, may gain access to the UWB spectrum. An OFDM carrier signal is the sum of a number of orthogonal subcarriers. Baseband data on each subcarrier is independently modulated. The composite baseband signal is typically used to modulate a main RF carrier. OFDM modulation and demodulation may be implemented using digital filter banks generally using the fast Fourier Transform (FFT) scheme. An example of OFDM symbol structure and frequency hopping patterns are disclosed in Multiband OFDM Physical Layer Specification, Release 1.0, Jan. 14, 2005, which is incorporated herein by reference.

Ultrawideband communication systems communicate information using what may be considered a large portion of frequency spectrum. For example, UWB systems may use frequencies between 3.1-10.6 GHz. This portion of the frequency spectrum may also be used by other communication systems. Many of these systems may be licensed to transmit at discrete frequencies within this spectrum, whereas UWB transmissions are generally authorized but unlicensed transmissions. Therefore, an intended UWB communication is subject to interference from interferer sources transmitting at frequencies falling within the same UWB range of frequencies. Similarly, UWB communications may interfere with other transmissions, some of which may be licensed by appropriate regulatory commissions.

Interference with other transmissions may degrade the capabilities of other communication systems, and may result in undesired effects. In some cases regulatory agencies may also prohibit UWB transmissions in certain narrow frequency ranges within the UWB frequency spectrum. Further, such other transmissions may also adversely impact reception of UWB signals.

### SUMMARY OF THE INVENTION

The invention provides a tone nulling method and system. In one aspect the invention provides a method for nulling tones in a UWB communication system, a tone comprising a range of frequencies falling within a predetermined frequency bin, the method comprising determining marked tones from among the tones; and nulling the marked tones at the transmitter, wherein the tones correspond to tones potentially produced by interferer sources.

In another aspect the invention provides a system for UWB communication of OFDM symbols, the system comprising a transmitter for transmitting the OFDM symbols, each OFDM symbol being comprised of information transmitted at a plurality of tones, each of the tones corresponding to a predetermined frequency bin; and a receiver for receiving other OFDM symbols; wherein the transmitter includes a tone mask used for removing marked tones from the tones of each OFDM symbol before transmitting the OFDM symbol, wherein the marked tones are tones falling in same frequency bins as tones from interferer sources transmitting at frequencies interfering with the UWB communication as determined by the receiver.

In another aspect the invention provides a method for removing interferer frequencies from OFDM symbols transmitted and received in UWB communication, the method comprising sensing a time-averaged energy level of tones during sense periods to obtain spectral histograms, one or more of the spectral histograms corresponding to each of the sense periods; identifying the interferer frequencies from each of the spectral histograms during the sense periods; and nulling the interferer frequencies in the OFDM symbols; transferring control to a ready state after each of the transmit periods, each of the receive periods, or each of the sense periods, wherein the transmit periods, the receive periods, and the sense periods do not overlap, and wherein each of the sense periods occurs periodically after one or more of the receive periods.

These and other aspects of the invention are more fully comprehended upon review of this disclosure.

### BRIEF DESCRIPTION OF THE DRAWINGS

FIG. 1 is a flow diagram of an exemplary tone nulling process according to the aspects of the present invention.

FIG. 2 is a flow diagram of an exemplary method for determining a tone mask for use in a tone nulling process according to the aspects of the present invention.

FIG. 3 is a block diagram of an OFDM receiver according to the aspects of the present invention.

FIG. 4 is a block diagram of an OFDM transmitter according to the aspects of the present invention.

FIG. 5 is a diagram showing an exemplary OFDM symbol structure and an exemplary frequency hopping pattern for the OFDM symbols.

FIG. 6 is a power spectral density plot of an exemplary UWB system showing narrowband interfering frequencies.

FIG. 7 is an exemplary state transition diagram for a wireless transmitter/receiver system implementing the physical layer of an UWB system according to the aspects of the present invention.

FIG. 8 is a plot of an exemplary spectral histogram showing averaged energy measurements according to the aspects of the present invention.

### DETAILED DESCRIPTION

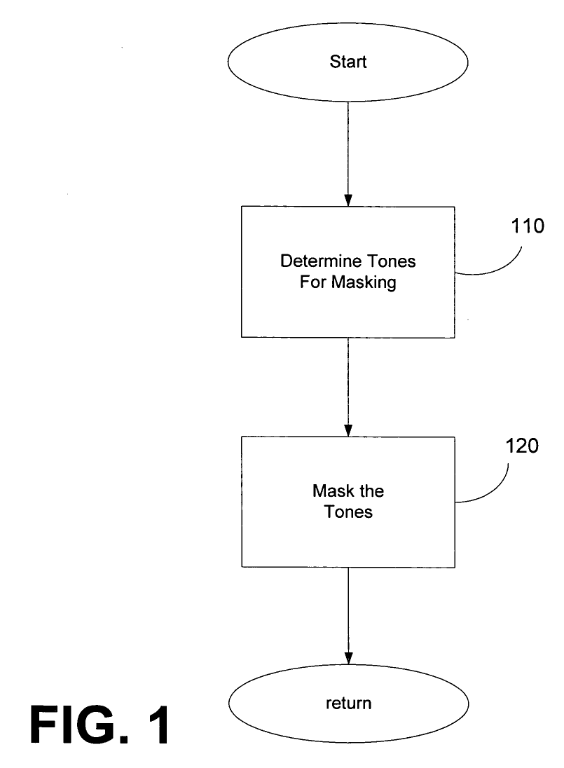

FIG. 1 is a flow diagram of a process for performing tone nulling. The tone nulling process may reduce interference effects on UWB communications and may reciprocally reduce interference effects resulting from the UWB communications on other communication systems.

In block 110 the process determines tones or subcarriers used in the UWB communication that are to be masked. In block 120, the process masks the tones or subcarriers determined in block 110. Masking removes the marked tones from the UWB communication or reduces their significance in the communication system. After masking the determined tones, the process returns.

In block 110, the tones to be masked may be predetermined tones, and may be tones determined by a regulatory agency as not available for use by UWB communication systems. The tones may also be predetermined according to other criteria.

Alternatively, the tones to be masked may be dynamically determined in the block 110 of the tone nulling process of FIG. 1. The process may monitor received energy levels at a receiver and determine whether the received energy levels fall within a masking criteria. The energy levels may be monitored over each of the tones the receiver is capable of receiving or for the frequencies falling within a range of the frequencies used in UWB communications. In some embodiments the monitoring of the received energy levels may performed by determining magnitudes of outputs from a fast Fourier Transform (FFT) block for received signals over each of the tones received by the receiver. In some embodiments the monitoring of the received energy levels may also be performed using a received signal strength indicator (RSSI) that is used to determine received signal strengths, with the RSSI correlated with appropriate frequency information. The process may determine the tones to be masked by determining which signal strengths exceed a predetermined threshold. The predetermined threshold may be set by a setting of a programmable register, by external circuitry, or by other means.

In block 120 of the process, the tones that are determined, or marked, for masking in block 110 are masked. Predetermined or constant marked tones may be provided to a transmitter via a chip or may be part of the hardware of the transmitter. For example, a bit map or table may be used by transmitter circuitry to zero, or null, tones determined appropriate for masking. The dynamically determined marked tones may be transmitted from the receiver to a transmitter associated with the receiver. More commonly, however, the transmitter and receiver are commonly located to form a transceiver, or effectively a transceiver, with the receiver portion of the transceiver providing an indication of tones for masking to the transmitter portion of the transceiver.

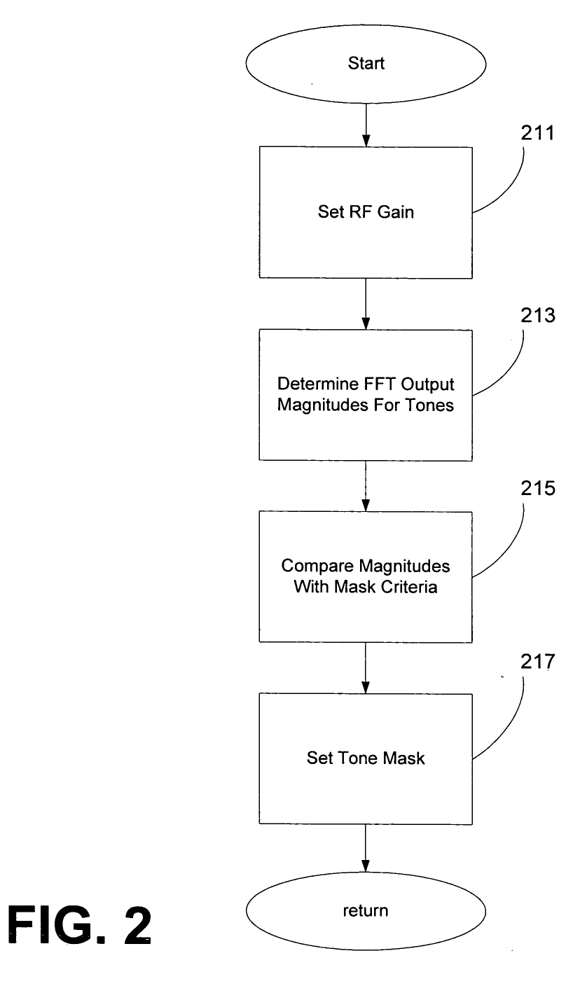

FIG. 2 is a flow diagram of a further process for determining tones to be masked. In block 211 the process sets an RF gain for a receiver. In many embodiments the process examines magnitudes of received symbols, and varying receiver gain between samplings may unduly impact tone mask determinations. In block 213 the process determines FFT output magnitudes for various tones as part of determining energy levels of the tones received at the receiver. Accordingly, in some embodiments, downconversion circuitry of the receiver is commanded to temporarily downconvert received signals for each of the tones for further processing, including processing by an FFT block. In some embodiments, during such processing automatic gain controls are set to a predetermined level. Also, in some embodiments, the magnitude of signal strength at different signals is determined by the complex magnitude of the outputs of the FFT block.

In block 215, the process compares the FFT output magnitudes with a predetermined mask criteria. If the output magnitudes fall within the mask criteria, the tones are included in the tone mask. In some embodiments the mask criteria may include a threshold. If the output magnitude of a tone exceeds the threshold value, the tone is included for masking. In block 217, the process sets a tone mask for use by transmission circuitry based on the tones whose magnitudes satisfy the mask criteria. The tone mask is used by transmission circuitry to mask, generally by zeroing or nulling tones, indicated by the tone mask. The process thereafter returns.

In one embodiment of the process the energy level for each subcarrier of an OFDM symbol is averaged and a spectral histogram developed from the averaged energy measurements. A criteria is set by the process for determining and marking the frequencies or the subcarriers that are to be nulled at the transmitter. For example, a threshold energy may be set and subcarriers or tones having an average energy above this threshold level are marked. Alternatively, a certain number of tones having the highest averaged energy may be marked for masking. A tone mask is set by the process, with the tone mask identifying tones marked for masking. The tone mask identifies tones for nulling at the transmitter. In one embodiment, the spectral energy measurements may be averaged over time according to a predetermined time window. Thus, the spectral histogram may be continuously or periodically updated upon repetition of the process and the updates of the spectral histogram may therefore account for changes in use of communication equipment that are transmitting using UWB frequencies.

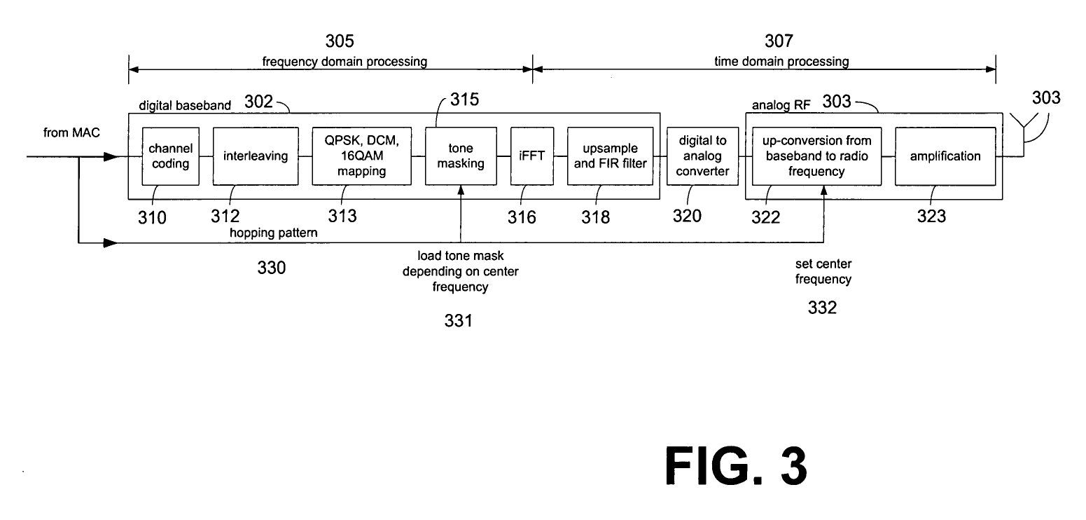

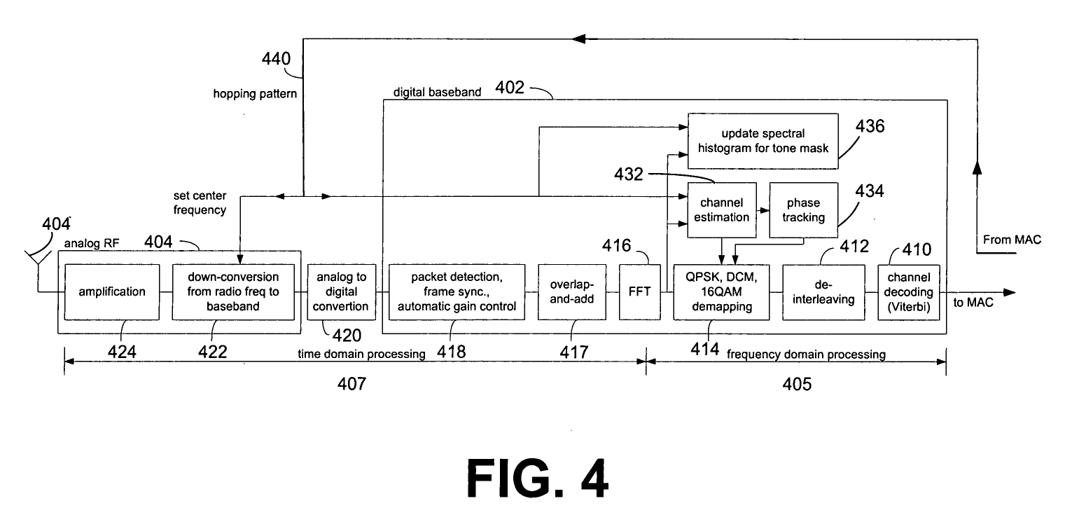

FIGS. 3 and 4 together provide block diagrams of a UWB transceiver. Often the components of FIGS. 3 and 4 will reside on a signal integrated circuit, with the components using a shared antenna and a shared MAC.

FIG. 3 is a block diagram of an orthogonal frequency division multiplexed (OFDM) transmitter. Generally the transmitter is formed of circuitry, potentially on an integrated circuit. Commonly receiver circuitry is also implemented on the integrated circuit as well. The transmitter includes a digital baseband stage and an analog RF stage that are coupled by a digital to analog conversion stage. The digital baseband performs digital stage processing of an OFDM signal for transmission. The processing may include encoding, modulating, tone masking and filtering of the signal. The signal is also converted from the frequency domain to the time domain in the digital baseband stage. The analog RF stage performs analog processing of the OFDM signal, including upconverting the signal to radio frequency and amplification of the signal before transmission. A frequency hopping pattern and a center frequency for the frequency hopped signal are set at the transmitter.

The exemplary transmitter includes blocks for channel encoding 310, interleaving 312, mapping 313, inverse fast Fourier Transform (iFFT) 316, and filtering 318 within the digital baseband processing stage 302. The digital based stage is followed by a block for digital to analog conversion 320. The analog RF stage 303 includes blocks for upconversion from baseband to radio frequency 322 and amplification 323. An antenna 303 is coupled to the amplification block 323, and radiates the radio frequency signal.

At the transmitter, channel encoding may be performed by the channel encoder 310 that encodes a bit stream of data from a medium access controller (MAC) (not shown) coupled to the transmitter. Depending on the rate of data in the bit stream one or more encoders may be used. The encoders may use a convolutional code. The encoded bit stream may be interleaved by an interleaver, which may include 312 a symbol interleaver and a tone interleaver, and mapped by a mapper 313 onto a constellation. Modulation schemes of QPSK or DCM may be used for mapping. A DCM constellation corresponds to two shifted QPSK constellations and effectively implements a 16 QAM constellation with a rate ½ repetition code over two subcarriers. Further repetition coding, referred to as conjugate symmetric spreading or frequency spreading, may also be applied.

The subcarriers in the signal are grouped into OFDM symbols where each OFDM symbol may include 128 subcarriers. The signal may then be transformed from frequency to time domain using a 128-point iFFT transformation by the iFFT block 316. After finite impulse response filtering by FIR block 318, the baseband signal is converted from the digital to the analog domain by the ADC block 320.

The transmitter also includes a tone masking block 315. The tone masking block is part of the digital baseband processing stage 302. As shown in FIG. 3, a tone mask is applied in the frequency domain before the iFFT block 316. Tone nulling is implemented, in some embodiments, by setting energy or amplitude of subcarriers that are marked for nulling to zero in the frequency domain at the transmitter. In some embodiments, tone nulling is accomplished using a tone masking block. The tone masking block nulls or masks certain of the UWB frequencies used by the transmitter. The frequencies marked for nulling may correspond to one or more subcarriers of an OFDM symbol. The subcarriers that are to be masked may be predetermined or may be provided to the tone mask dynamically. These subcarriers may be marked for nulling by various mechanisms and according to various criteria. A tone mask block used by the transmitter may be, for example, circuitry to null certain tones or subcarriers.

A pattern of the tone mask applied 331 may depend on the center frequency 332 of the OFDM symbol being processed, with the center frequency generally provided by the MAC. The pattern of the tone mask may be set to a predetermined pattern that is either internally fixed or externally provided to the transmitter. Alternatively, the pattern may be dynamically determined by a sensing mode implemented in the overall UWB communication system, and preferably implemented using receiver circuitry co-located on an integrated circuit or circuit based with the transmitter. Preferably each sub-band, such as a 528 MHz sub-band used for frequency hopping purposes, has its own dedicated tone mask.

In some embodiments, the tones marked for nulling by a tone mask that is used to perform the subcarrier nulling may be predetermined and fixed. The tones marked for nulling may be fixed according to regulatory specifications of a country to avoid interference with certain frequencies such as aviation navigation signals, mobile cellular frequencies, and frequencies used by other communication systems in that country. In other embodiments, the tones marked for nulling by the tone mask can be provided to a chip from an external interface. For example, the tone mask may be provided through registers that are set-up through a serial interface.

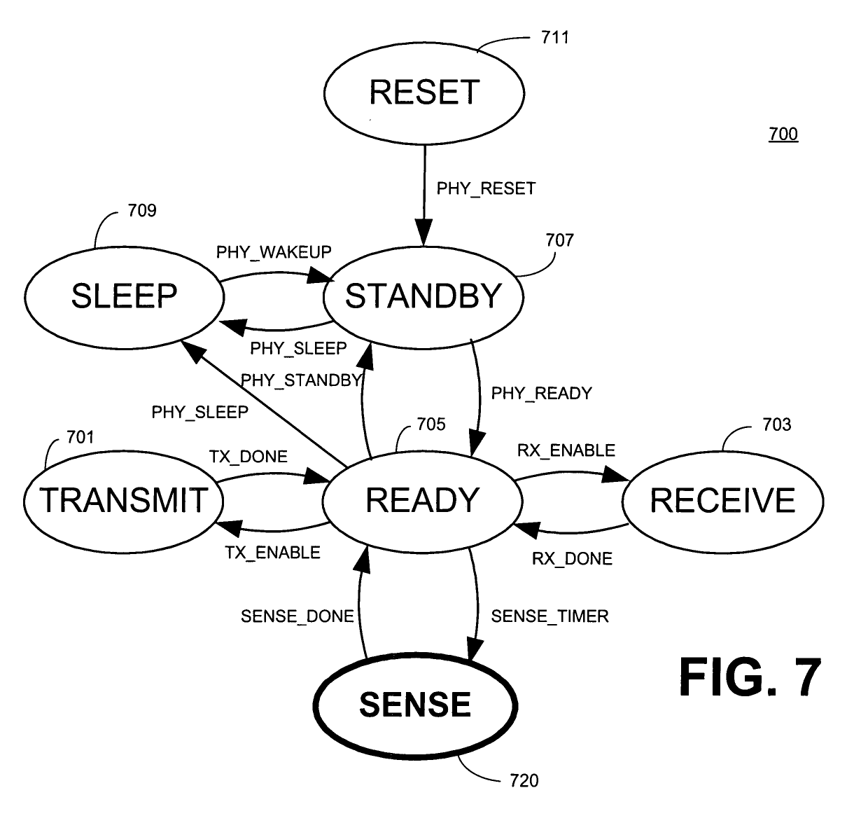

One dynamic method of determining the marked tones for nulling by the tone mask is to use a FFT module of a receiver of the transmission that must be partially nulled. In some embodiments, the FFT is used to perform an spectral analysis to determine on which subcarriers other interferers or communication systems are present. To obtain this information, a state machine of the UWB transmitter and receiver (see, FIG. 7), referred to as a transceiver, may be augmented by an additional state for sensing the frequencies that are being commonly used by the narrowband interferers as well as the UWB tranceiver.

At the transmitter, the processing moves from the frequency domain to the time domain during the digital baseband processing stage. The frequency domain processing may extend to the iFFT step. In UWB systems, the tone masking blocks operate between the mapping blocks and the iFFT blocks and fall within the frequency domain processing. Because the UWB system may implement frequency hopping from one OFDM symbol to the next, the tone mask, or the tone mask used, is changed according to the frequency hopping pattern in some embodiments. The center frequency of each OFDM symbol is provided to the tone mask.

Some of the embodiments of the present invention may use a dedicated tone mask for nulling the interfering frequencies for each subband of bandwidth 528 MHz. In an exemplary embodiment, for 3×128 OFDM subcarriers occupying a total bandwidth of 3×528 MHz, the tone mask used for subcarrier nulling has 3×128=384 binary entries.

Depending on how many subcarriers are set to zero during the tone masking, the quality of the transmitted UWB signal may degrade. The degradation in signal quality may be experienced by a receiver as a reduction in signal-to-noise ratio (SNR). However, an exemplary UWB system may have several different data rates with different SNR requirements that range from a high SNR for a data rate of 480 Mbps to a low SNR for a data rate of 53.3 Mbps. For example, the data rate of 53.3 Mbps uses very strong error correcting coding, with an effective rate of 1/12. Thus, at the data rate of 53.3 Mbps, for each 1 information bit there are 12 coded bits transmitted over the physical waveform channel. Due to this redundancy in the transmitted signal, nulling out a few subcarriers at the transmitter can be tolerated. For example, in some embodiments approximately up to 20 tones per each 128 point iFFT, i.e., per each 528 MHz bandwidth, may be nulled without significant deterioration in the SNR of the received sample.

FIG. 4 is a block diagram of a receiver in accordance with aspects of the invention. The receiver includes an analog RF stage 404 and a digital baseband stage 402 that are coupled through analog to digital conversion. A signal transmitted by a transmitter (such as the transmitter described with respect to FIG. 4) and received by the receiver is in analog form. The analog RF stage amplifies the signal and downconverts it from radio frequency to baseband. Then, during digital baseband processing, the signal is further processed and transformed from time domain 407 into frequency domain 405. In the frequency domain, the signal is demodulated and decoded before being provided to further receiving system elements.

The receiver receives the transmitted signal through an antenna 403 and includes an amplification block 424 and a downconversion block 422 for performing the analog RF stage processing. The signal undergoes analog to digital conversion by an ADC block 420. In the digital baseband processing 402, the receiver includes a signal processing block 418, an overlap-and-add block 417, an FFT block 416, a demapper 414, a deinterleaver 412, and a decoder 410. Additionally, a channel estimation block 432 is coupled to the FFT block and the demapper, and a phase tracking block 434 is coupled to the channel estimation block and the demapper. A tone analysis block 426 also is coupled to the FFT block. The tone analysis block is used in determination of tones, or frequencies, for nulling.

The signal received at the antenna 404 is amplified by amplification block 424, and downconverted by the downconversion block 422 from passband to baseband. A received signal strength indication (RSSI) signal is provided to the baseband to perform automatic gain control. During downconversion, frequency hopping pattern 430 according to a time-frequency code (TFC) number is taken into account. The hopping pattern is provided to the downconversion block 422 by a MAC (not shown) of the receiver.

After downconversion from radio frequency to baseband, the baseband signal is converted from analog format to digital format by the ADC block 420. Processing of the digital baseband signal then begins. The digital baseband processing 402 may include signal processing by signal processing block, including 418 packet detection, frame synchronization, and automatic gain control processing.

After analog to digital conversion, the signal processing block 418 detects the beginning of a packet of data using cross-correlation, auto-correlation and signal energy computation based on known preamble sequences. During a preamble of the packet, automatic gain control is performed using an analog-to-digital converted version of the RSSI signal from the analog RF stage 404. Automatic gain control, in some embodiments, includes the computation of gain settings for a low-noise amplifier (LNA), a mixer, and a programmable gain amplifier (PGA), in a first coarse automatic gain control (CAGC) including the LNA, the mixer, the PGA, and a second fine automatic gain control (FAGC) only using a PGA. The signal processing block 418 may be followed by the overlap-and-add block 417 that is used to remove a null prefix of the OFDM symbols in the time domain.

The signal processing block 418 takes the time-aligned sample stream in the time domain, and recovers the information or data bits, to be delivered to the receiver MAC.

The FFT block transforms the time domain signal to the frequency domain. The frequency domain signal is provided to the demapper for demapping and further processing. The frequency domain signal is also provided to the channel estimation block for channel estimation purposes and the tone analysis block 436 for tone mask determination purposes. In many embodiments the receiver does not perform overlap-and-add functions for symbols expected to be used for tone mask determination purposes. In many embodiments, of course, the tone analysis block does not necessarily perform analysis on data carrying symbols, but instead examines outputs of the FFT block that correspond to received transmissions over FFT symbol window periods.

The tone analysis block updates a spectral histogram of subcarrier energy levels for use by the tone mask. The spectral histogram is formed by measuring the energy level in each of the subcarriers of one symbol, such as an OFDM symbol or equivalent FFT window used to determine an OFDM symbol.

For example, each subcarrier includes a narrow band of frequencies and each frequency within the subcarrier has a corresponding energy level that is measured by the FFT operation. The measured energy levels of the frequencies within a narrow range of frequencies assigned to one subcarrier are averaged over a window of time. The time averaging may be done over a one OFDM symbol period of time. For example, for an OFDM symbol having a bandwidth of 528 MHZ, a time window of 1/528000000 of second may be used. In some embodiments energy measured during this period corresponding to each subcarrier is divided by the length of this period. Alternatively, the window of time used for time averaging the energy arriving at the receiver may be a moving window of time. The measured and time averaged energy level may be assigned to a frequency bin corresponding to the subcarrier. As a result, a spectral histogram may be developed that has one averaged energy measurement for each subcarrier.

The tone analysis block 436 may also receive the frequency hopping pattern 430 from the MAC and the averaged energy levels for the frequency spectrum of the received signal from the FFT block 416. The tone analysis block 436 may then update the marked tones that may be used by a tone masking block 315 of the transmitter based on the updated spectral histogram provided by the FFT block 416. Moreover, as explained below, overlap and add operation 417 and packet detection and frame synchronization of the signal processing 418 may be omitted in some embodiments.

In some embodiments channel estimation by the channel estimation block 432 may use the last 6 OFDM symbols of the preamble, as channel estimation symbols, to estimate the channel coefficients of each OFDM subcarrier. Phase estimation or tracking by the phase tracking block 444 uses embedded pilot tones to estimate the phase offset. The embedded pilot tones may consist of 12 tones or 12 subcarriers of the OFDM symbol. Channel and phase estimates are used to compensate the effects of multipath fading channels and phase/frequency offset. Frequency and/or conjugate symmetric despreading is applied prior to demapping. The demapper 414 recovers soft reliability bit estimates for the encoded bits. The demapper may use quadrature phase shift keying (QPSK) or dual carrier modulation (DCM), or 16 quadrature amplitude modulation (16 QAM) schemes.

After demapping the soft bit estimates are deinterleaved by a tone deinterleaver. Then, the encoded bits of the even and odd OFDM symbol stream are merged in a symbol deinterleaver. After tone and symbol deinterleaving, the encoded bits are depunctured and fed to the decoder 410 for channel decoding, for example using the Viterbi decoding method. When data is received at a high data rate, the Viterbi decoding may be implemented using two parallel block Viterbi decoders that operate on different parts of the deinterleaver output.

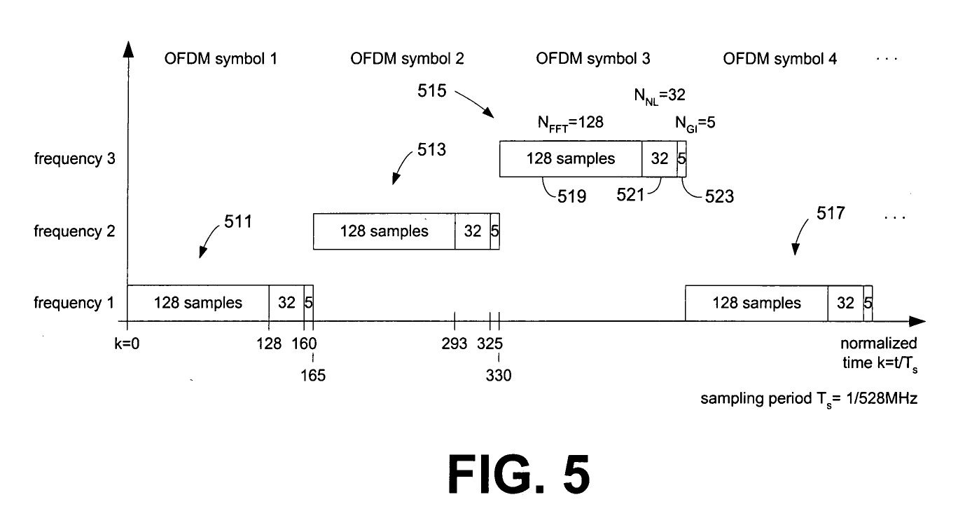

FIG. 5 is a diagram of an OFDM symbol structure and a frequency hopping pattern of the OFDM symbols. As shown in FIG. 5, the OFDM symbol includes a predetermined number of samples that are divided into several categories or groups. Some groups of the samples include the data being transmitted. Other groups of samples do not include any data or include a repetition of earlier data and are used for processing of the OFDM symbol. Other groups of samples are used to guard against the effects of interference between symbols that arrive successively through different channels and are subject to path dispersion. Also, shown in FIG. 5 is the frequency hopping pattern of the OFDM symbols. The symbols may stay in the same frequency band or may hop from band to band according to a pattern.

FIG. 5 shows an exemplary frequency hopping pattern for the OFDM symbols versus a normalized time k=t/Ts where Ts is defined as the sampling period. The sampling period Ts is equal to the inverse of the transmission frequency bandwidth or sampling frequency of each OFDM symbol such that Ts=1/f.

In the digital baseband stage, an exemplary OFDM symbol of a UWB system includes 165 complex samples at a sampling frequency of 528 MHz=1/Tₛ. A number equal to N_{FFT}=128 samples are usable and form the FFT-window size. Null samples having a number N_{NL}=32 samples are set to zero at the transmitter. A null prefix having N_{NL}=32 samples is shown as a postfix here, but referred to as prefix. A number of N_{G1}=5 samples form a guard interval or guard time and are set to zero at the transmitter to buffer any transient effects during frequency hopping.

In most OFDM systems like WLAN 802.11a/g, the N_{NL} samples following the first N_{FFT} samples are copies of the first N_{NL} samples of the N_{FFT}-part which are the first N_{FFT} samples of OFDM symbol. This arrangement is referred to as cyclic prefix. Alternatively, a null prefix may be used that sets the N_{NL} samples following the first N_{FFT} samples to zero. The use of a null prefix may allow, for example, for increased effective transmitter power.

All OFDM symbols may be transmitted on a same frequency or as shown in FIG. 5, each OFDM symbol may be transmitted on a different frequency according to a TFC pattern. A frequency-hopped OFDM may be implemented where the center frequency of the transmitted OFDM symbol is changed for every OFDM symbol according to a TFC pattern of the OFDM transmission. This is referred to as time-frequency interleaving.

The frequency hopping occurs at the end of the OFDM symbol. For example, in FIG. 5 the frequency hops at discrete time k=160 during the guard interval N_{G1} that includes 5 samples. The transient effects, resulting from switching of RF frequency at hops, are supposed to happen during the guard interval. Therefore, the N_{G1} samples of the guard interval are invalid and are discarded, such that they are not further used in the digital baseband processing. The null interval may also be used to address the effects of intersymbol interference. The overlap and add block of a receiver may utilize the null interval to remove the noise introduced by the transmission channel.

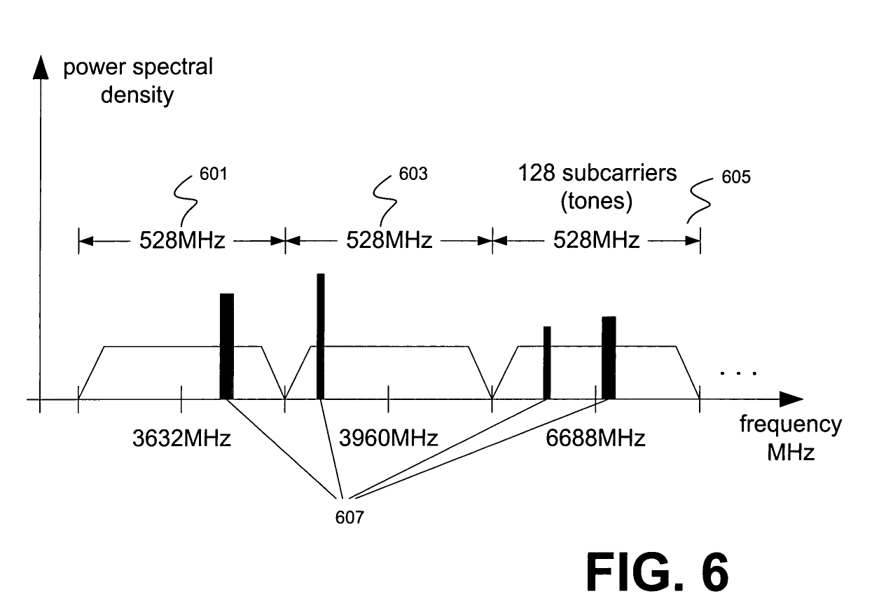

FIG. 6 is a power spectral density plot of an exemplary UWB system. An UWB transmission may occupy a wide range of frequencies that are open for use by various users. Some of the common users are narrowband sources that may utilize a few MHz of radio frequencies that overlap the wide band being used by the UWB transmission. For example, the spectrum from 3.168 GHz to 10.560 GHz, that corresponds to a UWB band of frequencies, is largely licensed for use by other services. The UWB transmissions in this spectrum may interfere with use of the spectrum by licensed users. Some of the narrowband radio wave emitters operating within this spectrum may include microwave ovens, or other electronic devices, as well as other communication systems, for example, WiMAX WAN, Wireless LAN and the like. These and other narrowband emitters cause interference with the UWB transmission and the interference needs to be addressed.

The exemplary UWB system of FIG. 6 operates in the frequency range from 3.168 GHz up to 10.560 GHz. This frequency range is subdivided into 5 band groups that are not shown. Initial UWB devices operate in band group 1 that ranges from 3.168 GHz to 4.752 GHz. The band group 1 is itself subdivided into the three subbands of 528 MHz bandwidth each.

The power spectral density shown in FIG. 6 relates to band group 1 of a UWB system. Three subbands 601 each having a bandwidth of 528 MHz are shown. Each subband 601 includes 128 subcarriers or tones. Power spectra of a number of narrowband interferers 603 are superimposed over the spectrum of the transmitted data.

Generally, bandwidths 603 of other interfering radio frequency emission sources operating in the UWB frequency range of 3.168 GHz to 10.560 GHz are much smaller than the bandwidth of UWB devices. The narrow bandwidths 603 of the interfering radio frequency emission source may be of the order of a few MHz. These emission sources are, therefore, referred to as narrowband interferers. Each subcarrier or tone of an exemplary UWB system has a bandwidth of about 528 MHz/128=4.125 MHz. Thus, a typical bandwidth 603 of a narrowband interferer corresponds to a few subcarriers of the OFDM symbol.

Embodiments of the present invention use tone nulling at a transmitter of the OFDM symbols to avoid contributing to interference at predetermined frequency bins. Accordingly, the embodiments of the present invention save power, as UWB frequencies that are interfered with by other radio frequencies are not further considered for communication of information.

FIG. 7 is an exemplary state transition diagram for a wireless tranceiver system implementing the physical layer of a UWB communication system. The state machine of FIG. 7 shows various states that a tranceiver system may take. The transciever may be in transmit or receive states. In between transmit and receive, it may be in a ready state where it is ready to either transmit or receive. The tranceiver system starts in a reset state and before going to ready passes through a standby state and may go to a sleep state from ready or standby. An added state of sense is also included in the tranceiver system of FIG. 7 that indicates a spectral sensing being performed by the tranceiver system. For spectral sensing to begin, the device must first be in the ready state. The spectral sensing may be triggered on a periodic basis or by a control signal from the ready state. For a periodic spectral sensing operation, the tones marked for nulling are updated every time the spectral sensing operation repeats. Transmit or receive may not occur concurrently with sense and the sense state signals completion of the sense operation to the ready state before transmit or receive may operate.

The exemplary state transition diagram includes states of TRANSMIT 701, RECEIVE 703, READY 705, STANDBY 707, SLEEP 709, and RESET 711 for the UWB transceiver. Signals TX_ENABLE, TX_DONE, RX_ENABLE, RX_DONE, PHY_READY, PHY_STANDBY, PHY_SLEEP, PHY_WAKEUP, and PHY_RESET shown on arrows between the states of the state transition diagram trigger the state transitions and may be provided from an internal component, or from an external device such as a MAC.

A separate state called SENSE 720 is also included that indicates the spectral sensing performed by the tranceiver. The spectral sensing is triggered by a control signal “SENSE_TIMER” on a periodic basis when the device is neither in the TRANSMIT nor in the RECEIVE state. Before spectral sensing, the device is in the READY state. A control signal SENSE_DONE may be used to signal the completion of spectral sensing to the READY 705 state.

The control signal SENSE_TIMER may be entered periodically, for example, every 50 ms. A period of the SENSE_TIMER may be specified by register settings. When the SENSE_TIMER is entered periodically, then the spectral sensing operation occurs periodically and the tones marked for nulling are updated every time the spectral sensing operation repeats. For example, the SENSE mode may be triggered after each OFDM symbol that is received by the receiver of the tranceiver system. Then, the marked tones that are to be nulled or deleted at the transmitter are updated for each OFDM symbol being transmitted.

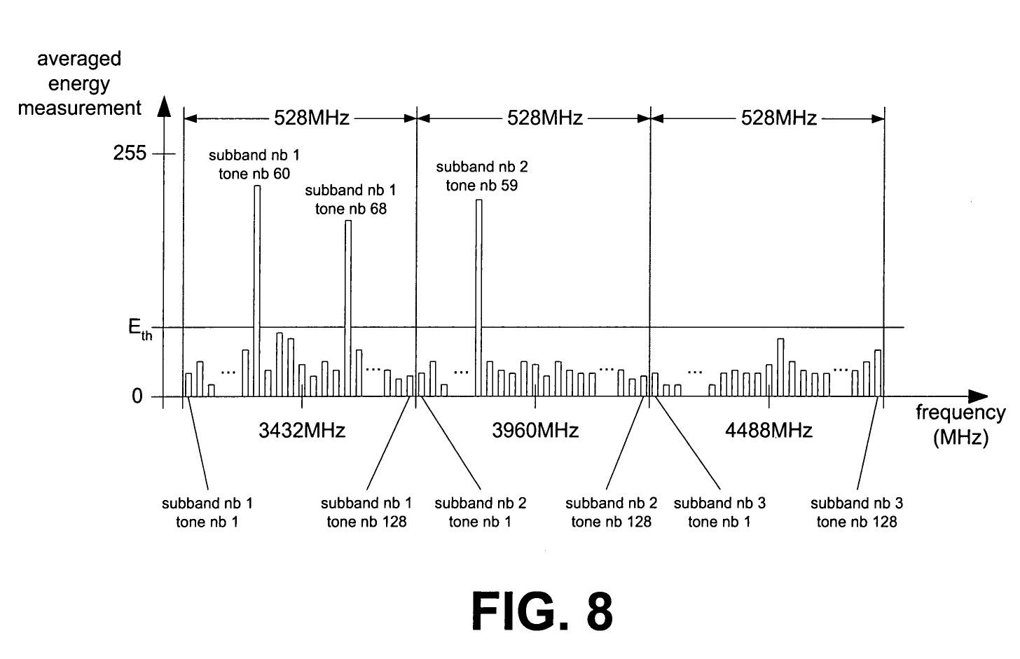

In the SENSE state, a receiver monitors received energy levels. For example, an FFT block of a receiver chain may measure energy levels on each of the 128 subcarriers per subband for each of the three subbands used in the UWB communication. Overlap-and-add operations, used with OFDM symbols with a null prefix, may cause distortion in the frequency domain. Therefore, in the SENSE state of the transceiver state machine, generally no overlap-and-add operation is performed. In addition, generally in the SENSE state packet detection and frame synchronization is not performed. In some embodiments, during the energy measurement, on RF gain of the receiver chain is set by automatic gain control circuitry to have a 5-10% clipping rate on analog to digital conversion. This clipping rate helps ensure full dynamic range of the analog to digital conversion for energy measurement. The energy level may be measured using outputs of the FFT block 316, which are complex values. Therefore, magnitudes of the outputs of the FFT may be computed and used to form the spectral histogram. An example of such a spectral histogram is shown in FIG. 8.

FIG. 8 is a plot of an exemplary spectral histogram showing averaged measurements of energy in each subcarrier frequency output by a FFT block in a receiver such as the receiver of FIG. 3.

The spectral histogram developed from averaged energy measurements of the FFT block of the receiver includes an energy level for each subcarrier. A criteria is set for determining and marking the frequencies or the subcarriers that are to be nulled at the transmitter. For example, a threshold energy may be set and subcarriers or tones having an averaged energy above this threshold level are marked for nulling.

FIG. 8 shows the averaged energy measurements for the subcarriers included in the three subbands of 528 MHz bandwidth each. Each subband includes 128 subcarriers. A possible threshold for tone masking is shown as Eₜₕ. Tones having an averaged energy above Eₜₕ may be marked for nulling.

In the spectral histogram of FIG. 8, all spectral energy measurements performed in SENSE state are averaged over time according to a predetermined time window. Thus, the histogram which is used for determining the nulling mask is continuously or periodically updated according to the time-varying interference scenario. The time-varying updates of the spectral histogram are performed slowly and depend on the time-varying interference scenario by other communication equipment that are interfering with the UWB frequencies and are switched on or off.

In different embodiments, different criteria may be used for selecting the marked tones that are marked for being nulled at the transmitter. In some embodiments, the marked tones to be nulled by the tone mask are determined from the spectral histogram of the FFT output according to certain criteria. The criteria used for determining the tone mask may include masking out a constant number N of the tones with the strongest average measured energy level from transmission for each subband of 128 subcarriers (i.e., tones). For example, N=10 tones or 10 subcarriers may be masked out of the total of 128 tones in a subband. The 10 masked tones are those having the largest average energy measured in the spectral update step performed by the tone and of the receiver. The criteria used for determining the tone mask may include masking out all tones exceeding a certain threshold Eₜₕ energy while the total number of tones being masked out must not exceed a predetermined number of M. The average energy Eₜₕ may be obtained based on the average of all tones. The average energy Eₜₕ may be set equal to the average of energy of all tones times a constant factor defined by a register setting. The constant factor may be set to 1.5. Using this criteria, for example, all but not more than M=10 tones exceeding 1.5 times the average of the energy of all of the tones are masked out.

After averaging FFT outputs over a predetermined time and after updating the spectral histogram of FIG. 8 that is used for determining the nulling mask, the tranceiver state machine leaves the SENSE state and enters the READY state. From the READY state, the transceiver state machine is ready to go to TRANSMIT, RECEIVE, or back again to SENSE, depending on the control signals and timer signals from the transmitter MAC and the receiver MAC.

Although the present invention has been described with reference to certain exemplary embodiments, it is understood that a variety of modifications and variations may be made to the present invention without departing from the spirit or scope of the invention defined in the appended claims, and their equivalents.

What is claimed is:

1. A method for nulling tones in a UWB communication system, a tone comprising a range of frequencies falling within a predetermined frequency bin, the method comprising:
determining marked tones from among the tones; and
nulling the marked tones by the transmitter,
wherein the tones correspond to tones potentially produced by interferer sources.

2. The method of claim 1, wherein the marked tones are either fixed or provided by an external source.

3. The method of claim 1, wherein the UWB band includes a plurality of subbands of frequency, the method further comprising:
updating the marked tones for each of the subbands.

4. The method of claim 3,
wherein each of the subbands is 528 MHz wide,
wherein each of the OFDM symbols includes 128 OFDM tones and occupies one of the subbands,
wherein each of the OFDM tones occupies substantially 4.125 MHz of frequency bandwidth, and
wherein the nulling of the marked tones at the transmitter includes:
setting subcarriers corresponding to the tones to zero in the frequency domain.

5. The method of claim 1,
wherein the determining of the marked tones is performed by a receiver.

6. The method of claim 5, wherein the determining of the marked tones includes:
forming a spectral histogram from time-averaged measured energy levels in received UWB tones, the received UWB tones being received by the receiver.

7. The method of claim 6, wherein the time-averaged measured energy levels are averaged over a time varying window of time.

8. The method of claim 6, wherein the time-averaged measured energy levels are averaged over a constant window of time.

9. The method of claim 6, wherein the determining of the marked tones further includes:
selecting a constant preset number of the received UWB tones having the strongest time-averaged measured energy levels as the marked tones.

10. The method of claim 6, wherein the determining of the marked tones further includes:
selecting a first number of the received UWB tones exceeding a threshold energy level as the marked tones, the first number being variable from one OFDM symbol period to a next OFDM symbol period,
wherein the threshold energy level is equal to an average of the time-averaged measured energy levels of all OFDM tones of all the OFDM symbols within the UWB band times a constant factor, and
wherein the first number is determined to be less than or equal to a constant number.

11. The method of claim 10,
wherein the constant factor is equal to 1.5, and
wherein the constant number is equal to 10.

12. A system for UWB communication of OFDM symbols, the system comprising:
a transmitter for transmitting the OFDM symbols, each OFDM symbol being comprised of information transmitted at a plurality of tones, each of the tones corresponding to a predetermined frequency bin; and
a receiver for receiving other OFDM symbols;
wherein the transmitter includes a tone mask used for removing marked tones from the tones of each OFDM symbol before transmitting the OFDM symbol,
wherein the marked tones are tones falling in same frequency bins as tones from interferer sources transmitting at frequencies interfering with the UWB communication as determined by the receiver.

13. The system of claim 12, wherein the transmitter includes:
a channel encoder for receiving the OFDM symbols from a medium access controller and producing encoded symbols;
an interleaver coupled to the channel encoder for producing interleaved symbols;
a mapper coupled to the interleaver for producing mapped symbols;
the tone mask coupled to the mapper;
an inverse fast Fourier transform machine coupled to the tone mask for producing time domain symbols from frequency domain symbols received from the tone mask;
a filter coupled to the inverse fast Fourier machine for producing digital filtered symbols;
a digital to analog converter coupled to the filter for producing analog symbols from the digital filtered symbols received from the filter;
an analog radio frequency portion coupled to the digital to analog converter for producing upconverted amplified symbols; and
a transmitter antenna coupled to the analog radio frequency portion for transmitting the upconverted amplified symbols to the receiver,
wherein a time-frequency hopping pattern of the OFDM symbols is provided to the analog radio frequency portion for setting a center frequency for the upconverted amplified symbols, and
wherein the time-frequency hopping pattern of the OFDM symbols is provided to the tone mask for loading the marked tones corresponding to the center frequency of the upconverted amplified symbols.

14. The system of claim 13, wherein the tone mask includes:
a register for storing the marked tones provided from an external source.

15. The system of claim 12, wherein the receiver includes:
an analog radio frequency portion coupled to an antenna for producing down-converted symbols;
an analog to digital converter coupled to the analog radio frequency portion for producing digital symbols;
a signal processing portion coupled to the analog to digital converter for producing processed symbols;
a fast Fourier transform machine coupled to the signal processing portion for producing OFDM symbols in frequency domain;
a demapper coupled to the fast Fourier transform machine for producing demapped symbols;
a deinterleaver coupled to the demapper for producing de-interleaved symbols;
a channel decoder for producing decoded OFDM symbols and for sending the decoded OFDM symbols to a medium access controller; and
circuitry coupled to the fast Fourier transform machine for forming spectral histograms of time-averaged power levels of the tones in each of the OFDM symbols in the frequency domain and for updating the spectral histograms,
wherein a time-frequency hopping pattern of the OFDM symbols is provided to the analog radio frequency portion for setting a center frequency for the downconverted symbols, and
wherein the time-frequency hopping pattern of the OFDM symbols is provided to the circuitry for forming each of the spectral histograms centered about a center frequency of a corresponding one of the OFDM symbols.

16. The system of claim 15, wherein the circuitry updates the spectral histograms for each OFDM symbol.

17. The system of claim 15, wherein the circuitry updates the spectral histograms continuously.

18. A method for removing interferer frequencies from OFDM symbols transmitted and received in UWB communication, the method comprising:
sensing a time-averaged energy level of tones during sense periods to obtain spectral histograms, one or more of the spectral histograms corresponding to each of the sense periods;
identifying the interferer frequencies from each of the spectral histograms during the sense periods; and
nulling the interferer frequencies in the OFDM symbols;
transferring control to a ready state after each of the transmit periods, each of the receive periods, or each of the sense periods,
wherein the transmit periods, the receive periods, and the sense periods do not overlap, and
wherein each of the sense periods occurs periodically after one or more of the receive periods.

19. The method of claim 18, further comprising:
performing a fast Fourier transform during the receive period after the receiving of the OFDM symbols;
averaging over a predetermined duration of time, an energy level of each tone of each OFDM symbol to obtain each of the spectral histograms; and
periodically updating the spectral histograms.

20. The method of claim 19,
wherein each OFDM symbol occupies a frequency subband being substantially 528 MHz wide,
wherein each OFDM symbol includes 128 tones, each tone occupying substantially 4.125 MHz of the frequency subband,
wherein the UWB communication occupies three frequency subbands each being substantially 528 MHz wide, and
wherein the UWB communication occupies frequencies substantially between 3168 MHz and 10560 MHz.

21. The method of claim 18, further comprising:
frequency domain processing of the OFDM symbols during the transmit periods before the transmitting of the OFDM symbols; and
inverse fast Fourier transforming of the OFDM symbols during the transmit periods after the frequency domain processing,
wherein each of the OFDM symbols includes a plurality of tones, each tone occupying a subcarrier bandwidth of frequencies,
wherein the nulling of the interferer frequencies is implemented by setting the tones having frequencies in common with the interferer frequencies to zero during the frequency domain processing and before the inverse fast Fourier transforming of the transmit periods.

22. The method of claim 21,
wherein each OFDM symbol occupies a frequency subband being substantially 528 MHz wide,
wherein each OFDM symbol includes 128 tones, each tone occupying substantially 4.125 MHz of the frequency subband, and
wherein the nulling of the interferer frequencies is implemented by setting fewer than 20 tones equal to zero.
